(19) United States
(12) Patent Application Publication
(10) Pub. No.: US 2009/0129756 A1
(43) Pub. Date: May 21, 2009

(54) METHOD AND DEVICE TO SEAMLESSLY REPRODUCE CONTENTS USING STORAGE MEDIUM

(75) Inventors: Seong-hun JEONG, Suwon-si (KR); Hong-seok Park, Ansan-si (KR); Yong-je Kim, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/179,691

(22) Filed: Jul. 25, 2008

(30) Foreign Application Priority Data
Nov. 15, 2007 (KR) 2007-116765

(51) Int. Cl. H04N 7/26

(52) U.S. Cl. 386/124; 386/E05.001

(57) ABSTRACT

A method and device to seamlessly reproduce contents includes receiving contents being reproduced in a first reproduction device from the first reproduction device, when the reproduction of the contents is stopped in the first reproduction device, receiving contents reproduction stopping point information from the first reproduction device, and outputting the contents and the contents reproduction stopping point information to a second reproduction device by using the contents reproduction stopping point information.

### CROSS-REFERENCE TO RELATED APPLICATIONS

This application claims priority under 35 U.S.C. §119(a) from Korean Patent Application No. 10-2007-0116765, filed on Nov. 15, 2007, in the Korean Intellectual Property Office, the disclosure of which is incorporated herein in its entirety by reference.

### BACKGROUND OF THE INVENTION

1. Field of the Invention

The present general inventive concept relates to a method and device to seamlessly reproduce contents by using a storage medium, and more particularly, to a method and device to seamlessly reproduce contents from a point where reproduction of contents is stopped in a previous reproduction device to a point where reproduction begins in a next reproduction device.

2. Description of the Related Art

Reproduction devices to reproduce or storing a wide variety of contents have become widely popular. The reproduction devices may include digital TVs (DTVs), personal video recorders (PVRs), personal computers (PCs), laptops, and mobile devices such as portable multimedia players (PMPs) and personal digital assistants (PDAs).

Due to an increase in the use of reproduction devices for enjoying audio/visual (AV) contents, each AV reproduction device has a separate contents storage space, and contents being enjoyed by a user are stored in and reproduced by a specific AV reproduction device.

Since the user can have various reproduction devices, a need for a function of seamlessly reproducing contents, while the user moves, increases.

FIG. 1 illustrates a scene seamlessly reproduced in different reproduction devices.

That is, seamless reproduction between reproduction devices refers to contents currently being viewed in a specific AV reproduction device 110 is moved to a different AV reproduction device 120 and is immediately viewed at a desired time in a desired reproduction point, as illustrated in FIG. 1.

FIG. 2A illustrates contents being shared by using a network according to the prior art.

An A/V reproduction device 210 in which the current contents are stored performs a role of a streaming server and transmits the corresponding contents and information on a contents reproducing location to a different reproduction device 250 through a network at a time desired by a user. The reproduction device 250 in which data is received can seamlessly reproduce the contents by using information on the contents reproducing location

However, when contents are shared through a network as illustrated in FIG. 2A, contents cannot be shared in an AV reproduction device not supporting a network connection. In addition, the use of wireless broadband internet is expensive and a high network bandwidth required for HD contents increases a cost of network use, when a range of movement is large.

FIG. 2B illustrates contents being shared by using a portable storage device according to the prior art.

When contents are reproduced in a specific reproduction device 220 and should be reproduced in another reproduction device 250 from a predetermined reproducing point, the contents and the contents reproducing information are copied from the reproduction device 220 into a storage medium 230 such as a secure digital (SD) card, and the storage medium 230 is input to other reproduction device 250 to share the contents.

However, when contents are shared using a separate storage medium, the contents are transmitted to the storage medium from the reproduction point when the user desires to change the reproduction device and the contents are modified to a desired reproduction format, and thus taking a lot of time to move the contents.

### SUMMARY OF THE INVENTION

The present general inventive concept provides a method of seamlessly reproducing contents in a reproduction device that is different from another reproduction device, in which existing media contents is reproduced, by efficiently moving the contents by using a storage medium from a point where reproduction of contents is stopped.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing a method of seamlessly reproducing contents, the method including receiving contents being reproduced in a first reproduction device from the first reproduction device, when the reproduction of the contents is stopped in the first reproduction device, receiving contents reproduction stopping point information from the first reproduction device, and outputting the contents and the contents reproduction stopping point information to a second reproduction device by using the contents reproduction stopping point information.

Receiving the contents may include determining whether a reproduction method of the contents is changed in the first reproduction device and, if so, converting the contents according to the changed reproduction method based on the determination result of the first reproduction device.

Receiving the contents may include reproducing the contents in the first reproduction device and simultaneously receiving the contents from the beginning from the first reproduction device.

In the receiving of the contents, a speed of storing the contents may be faster than a speed of reproducing the contents.

The reproduction method may include at least one of a compressed format, a total capacity of data, and a resolution of the contents.

Receiving contents reproduction stopping point information may include determining whether to wait until all contents are completely stored from the contents reproduction stopping point.

Outputting the contents and the contents reproduction stopping point information to the second reproduction device may include determining whether the contents are reproduced at the reproduction stopping point in the second reproduction device by using the contents and the contents reproduction stopping point information.

The first reproduction device may display a contents reproduction screen, a current contents reproducing location, and a current transmitting location.

The foregoing and/or other aspects and utilities of the general inventive concept may also be achieved by providing a device to seamlessly reproduce contents, the device including a contents input unit to receive contents being reproduced in a first reproduction device from the first reproduction device, a reproduction stopping point input unit to receive contents reproduction stopping point information from the first reproduction device, when the reproduction of the contents is stopped in the first reproduction device, and a contents output unit to output the contents and the contents reproduction stopping point information to a second reproduction device by using the contents reproduction stopping point information, in order for the contents to be seamlessly reproduced in the second reproduction device.

The contents output unit may include a seamless reproduction determining unit to determine whether the contents are reproduced from the reproduction stopping point in the second reproduction device by using the contents and the contents reproduction stopping point information.

The foregoing and/or other aspects and utilities of the general inventive concept may also be achieved by providing a computer readable recording medium having embodied thereon a computer program to execute a method, the method including receiving contents being reproduced in a first reproduction device from the first reproduction device, when the reproduction of the contents is stopped in the first reproduction device, receiving contents reproduction stopping point information from the first reproduction device, and outputting the contents and the contents reproduction stopping point information to the second reproduction device by using the contents reproduction stopping point information.

The foregoing and/or other aspects and utilities of the general inventive concept may also be achieved by providing a content reproduction apparatus including a storage medium, and a reproduction device to reproduce content by moving the content from a point where reproduction of content is stopped to a point where reproduction begins in an other reproduction device through the storage medium.

The foregoing and/or other aspects and utilities of the general inventive concept may also be achieved by providing a content reproduction system including a storage medium to store content, a display device to display the content, and a reproduction device to simultaneously transmit the content to the storage medium and the display device.

### BRIEF DESCRIPTION OF THE DRAWINGS

The above and other features and utilities of the present general inventive concept will become more apparent by describing in detail exemplary embodiments thereof with reference to the attached drawings in which:

FIG. 1 illustrates a scene seamlessly reproduced in different reproduction devices;

FIG. 2A illustrates contents being shared by using a network according to prior art;

FIG. 2B illustrates contents being shared by using a portable storage device according to prior art;

FIG. 3 is a block diagram illustrating a device to seamlessly reproduce contents according to an embodiment of the present general inventive concept;

FIG. 4 illustrates a method illustrating processing contents in a first reproduction device according to an embodiment of the present general inventive concept;

FIG. 5 is a detailed block diagram illustrating a first reproduction device according to an embodiment of the present general inventive concept;

FIG. 6 is a flowchart illustrating operations performed by a first device to seamlessly reproduce contents according to an embodiment of the present general inventive concept;

FIG. 7 illustrates a graphical user interface (GUI) of a first reproduction device according to an embodiment of the present general inventive concept; and

FIG. 8 illustrates a flowchart illustrating a method of seamlessly reproducing contents according to an embodiment of the present general inventive concept.

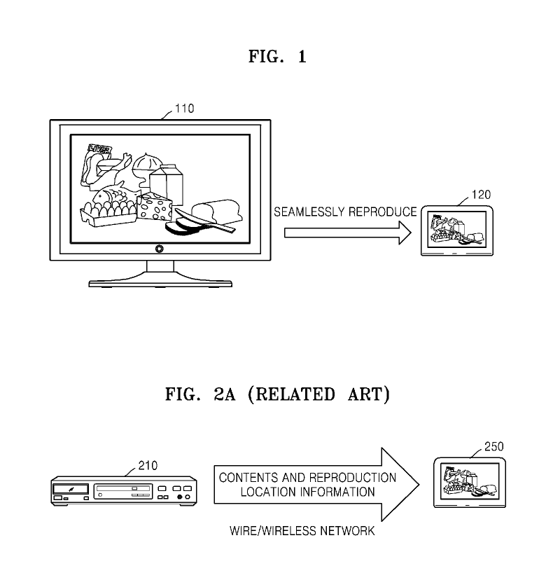

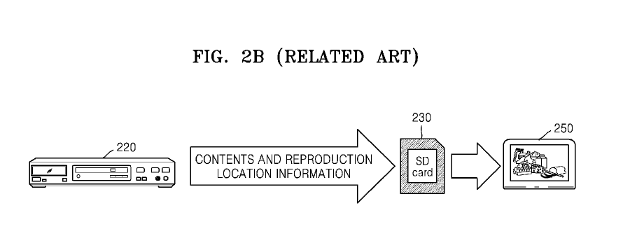

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

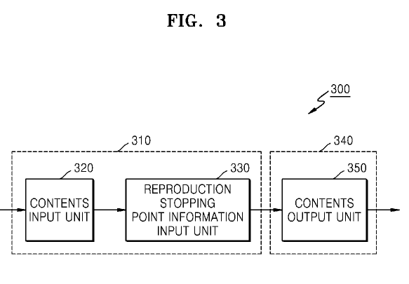

FIG. 3 is a block diagram of a device to seamlessly reproduce contents according to an embodiment of the present general inventive concept.

Referring to FIG. 3, a device to seamlessly reproduce contents 300 includes a contents input unit 320, a reproduction stopping point information input unit 330, and a contents output unit 350. The contents input unit 320 and the reproduction stopping point information input unit 330 are related to a first reproduction device 310 and the contents output unit 350 is related to a second reproduction device 340 to reproduce contents. In the present embodiment, contents are seamlessly reproduced using a storage medium so that the storage medium receives data from the first reproduction device (in section 310) and data is output to the second reproduction device (in section 340).

The contents input unit 320 receives the contents being reproduced in the first reproduction device 310 from the first reproduction device 310 and stores the received contents in the contents input unit 320.

The contents according to the present embodiment denote data including at least one of series data with respect to predetermined multimedia. For example, when the contents according to the embodiment of the present embodiment are related to a drama formed of a plurality of chapters, the contents include at least one chapter.

In the present embodiment, a portion of the contents is stored in a storage medium and in another embodiment of the present general inventive concept, entire contents can be stored in the storage medium. The storage medium may be a portable storage medium. When the contents according to the present embodiment are related to a drama formed of a plurality of chapters, the contents include at least one chapter so that the storage medium can store at least one specific chapter.

Although not illustrated in FIG. 3, the contents input unit 320 according to the present embodiment includes a converting unit to determine whether the method to reproduce contents is replaced by another method, i.e. the method to reproduce contents is converted, in the first reproduction device 310 to convert contents according to the replaced method to reproduce contents based on the result of the determination.

The reproduction method can contain at least a reproduction format based on each reproduction device, resolution, sound quality, and image quality of the contents. The reproduction method can be converted into an other specific reproduction method. In addition, in the present embodiment of the device to seamlessly reproduce contents 300, the conversion performed in the reproduction method is essential and thus the determining whether to convert is also essential. In another embodiment, the reproduction method arbitrarily desired by a user is selected so that whether to convert can be determined.

The contents input unit 320 starts reproducing the contents and transmits the contents to a storage medium simultaneously. Also, since a speed to store the contents is faster than a speed to reproduce the contents, the contents can be rapidly stored.

When the reproduction of the contents is stopped in the first reproduction device 310, the reproduction stopping point information input unit 330 receives information relating to a point at which reproduction is stopped from the first reproduction device 310 and stores the information. Finally, the storage medium contains the contents and the reproduction stopping point. The reproduction stopping point information input unit 330 determines whether to wait until all the contents are stored at the contents reproduction stopping point and stores the contents according to the determination.

As illustrated above, the contents may include all data with respect to related multimedia. Accordingly, the reproduction stopping point information input unit 330 determines whether to wait until all the contents are stored from the contents reproduction stopping point and stores the contents according to the determination.

The contents output unit 350 outputs the contents and the reproduction stopping point information to the second reproduction device 340 by using the reproduction stopping point information, in order for the contents to be seamlessly reproduced in the second reproduction device 340.

The contents output unit 350 determines whether the contents are reproduced from the reproduction stopping point in the second reproduction device 340 by using the reproduction stopping point information and the contents extracted from the storage medium.

Although not illustrated in FIG. 3, the first reproduction device 310 according to the present embodiment displays a current contents reproducing location and a current storing location transmitted to the storage medium, together with a contents reproduction screen.

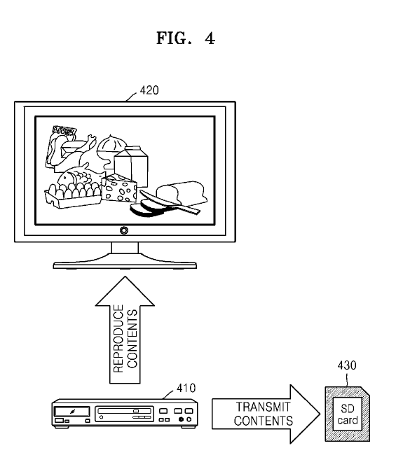

FIG. 4 illustrates a method of processing contents in a first reproduction device according to an embodiment of the present general inventive concept.

A device to reproduce the contents 410 corresponds to the first reproduction device of the device to seamlessly reproduce contents 300 illustrated in FIG. 3.

A display device 420 displays the contents reproduction screen by using the device to reproduce the contents 410. The device to reproduce the contents 410 reproduces the contents through the display device 420 and simultaneously transmits the contents to a storage medium 430 through the contents input unit 320 of the first reproduction device 310 to store the contents in the storage medium 430.

In the present embodiment, the display device 420 starts reproducing the contents and the contents input unit 320 simultaneously starts storing the contents in the storage medium 430.

In general, since a speed of storing the contents is faster than a speed of reproducing the contents, when reproduction and storage of the contents are simultaneously started, the contents are completely stored before the contents are completely reproduced.

In addition, when reproduction of the contents is stopped while being performed in the first reproduction device 310 (FIG. 3), the reproduction stopping point information input unit 330 transmits the reproduction stopping point information to the storage medium 430 to store the information in the storage medium 430.

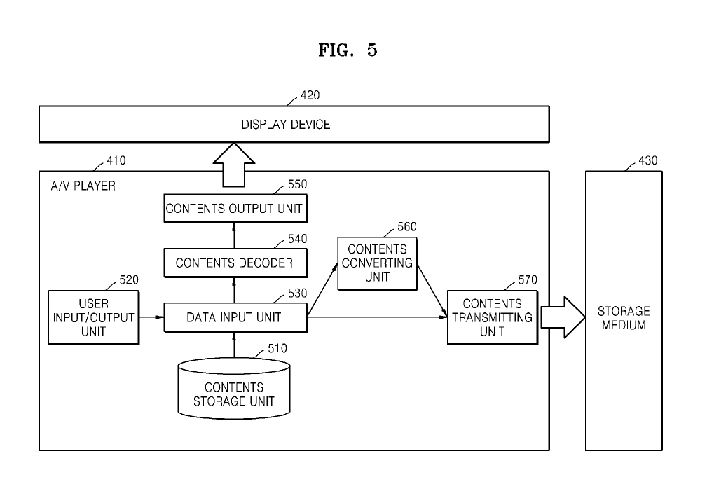

FIG. 5 is a detailed block diagram illustrating a first reproduction device according to an embodiment of the present general inventive concept.

In an embodiment, the first reproduction device 410, that is, the A/V player of FIG. 5, corresponds to the device to reproduce content of FIG. 4, and includes a contents storage unit 510, an user input/output unit 520, a data input unit 530, a contents decoder 540, a contents output unit 550, a contents converting unit 560, and contents transmitting unit 570.

In the present embodiment, the first reproduction device 410 stores the contents in the contents storage unit 510 and when a reproduction command is input by a user through the user input/output unit 520, the data input unit 530 calls the contents data from the contents storage unit 510. A form of the contents storage unit 510 may vary and may be in the form of, for example, a hard disc or a soft disc.

In the present embodiment, the first reproduction device 410 reproduces the contents and simultaneously records the contents in the storage medium. Accordingly, the contents decoder 540 and the contents output unit 550 decode and output the contents to be reproduced in the display device 420 and the data input unit 530 outputs the contents data to the contents converting unit 560 or the contents transmitting unit 570.

A reproduction format of the second reproduction device may be different from that of the first reproduction device 410 and the reproduction method may be changed in terms of, for example, reproduction resolution, sound quality, or image quality. Accordingly, in order to convert the reproduction format and the reproduction method, the contents converting unit 560 converts the reproduction method of the contents. The contents data in which the reproduction method of the contents does not need to be converted and the contents data in which the reproduction method thereof is converted through the contents converting unit 560 are transmitted to the storage medium 430 through the contents transmitting unit 570 and are recorded in the storage medium 430.

An A/V player illustrated in FIG. 5 corresponds to the first reproduction device 410 (of FIG. 4) and thus corresponds to the contents input unit 320 and the reproduction stopping point information input unit 330 of the device to seamlessly reproduce contents 300 of FIG. 3 according to an embodiment of the present general inventive concept.

That is, the device to seamlessly reproduce contents 300 receives the contents which are received from the contents storage unit 510 and the data input unit 530 of the first reproduction device 410 and are output through the contents decoder 540, contents output unit 550, and the display device 420.

In addition, the contents converting unit 560 and the contents transmitting unit 570 correspond to the contents input unit 320 of the device to seamlessly reproduce contents 300, wherein the contents converting unit 560 converts the reproduction method of the contents received from the contents storage unit 510 and the data input unit 530 and the contents transmitting unit 570 outputs the contents to the storage medium 430. Whether to output data to the contents input unit 320 and the reproduction stopping point information input unit 330 is determined according to whether the contents are reproduced or stopped through controlling by the user input/output unit 520.

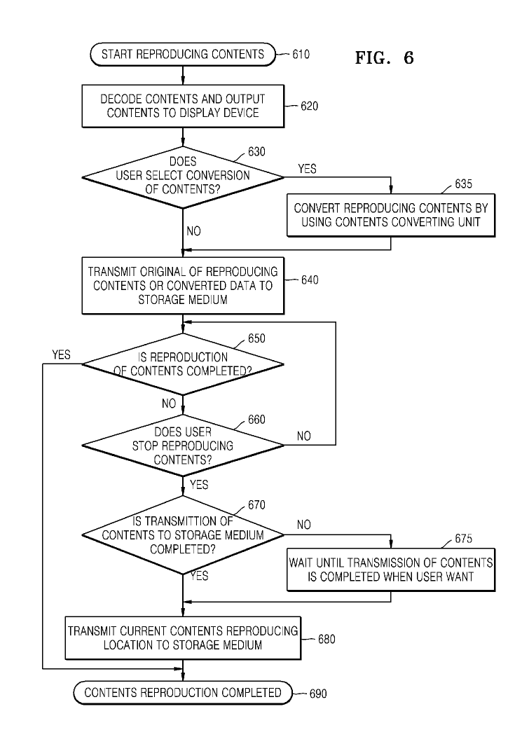

FIG. 6 is a flowchart of operations performed by a first device 410 to seamlessly reproduce contents according to an embodiment of the present general inventive concept.

Referring to FIGS. 3, 4 and 6, when the first reproduction device 410 receives a command to reproduce the contents in operation 610, the first reproduction device 410 decodes the contents data and starts reproducing and outputting the contents to the display device 420 in operation 620. The contents input unit 320 of the first reproduction device 410 reproduces the contents after determining whether the reproduction format or the reproduction method of the contents should be converted before storing the contents in the storage medium 430 in operation 630. When the contents should be converted, the contents are converted by using the contents converting unit 560 in operation 635.

The contents input unit 320 transmits the original of the reproducing contents or the contents data converted by the contents converting unit 560 to the storage medium 430 in operation 640. Whether the contents are completely reproduced is determined in operation 650. When the contents are completely reproduced, the first reproduction device 410 stops reproduction of the contents in operation 690 since the contents do not need to be reproduced from the reproduction stopping point in another reproduction device.

When the contents are not completely reproduced in the first reproduction device 410 in operation 650 and a user does not stop the reproduction of the contents in operation 660, the reproduction of the contents should be continued in the first reproduction device 410 and whether the contents are completely reproduced is again determined in operation 650.

When the user stops the reproduction of the contents in operation 660, the reproduction stopping point information input unit 330 determines whether the contents are completely transmitted to the storage medium 430 in operation 670. When the contents are not completely transmitted, the reproduction stopping point information input unit 330 selectively waits for all contents to be transmitted to the storage medium 430 in operation 675. When the contents are completely transmitted to the storage medium 430 in operations 670 and 675, the current contents reproducing location is transmitted to the storage medium 430 in operation 680.

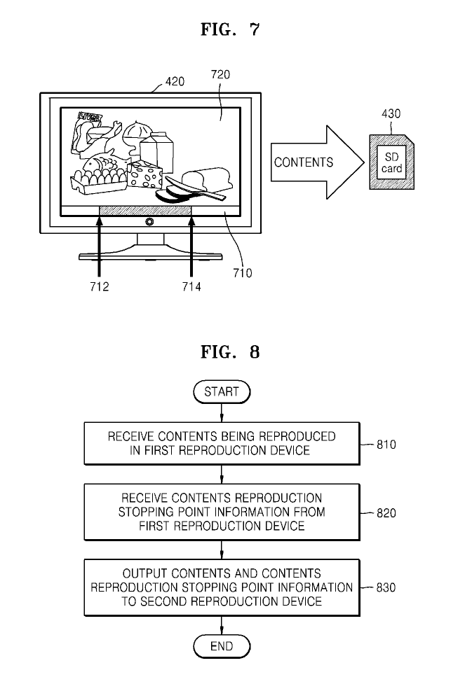

FIG. 7 illustrates a graphical user interface (GUI) of a first reproduction device according to an embodiment of the present general inventive concept.

The display device 420 of the first reproduction device according to the present general inventive concept displays a contents reproducing screen 720 and a time bar 710 indicating processing of the contents. The time bar 710 represents a current reproducing location 712 and a current transmitting location 714 of the storage medium 430.

Although not illustrated in the FIG. 7, when the user stops the reproduction of the contents, and the contents to the storage medium 430 are not yet completely transmitted, the display device 420 of the first reproduction device displays a selection window to be used to select whether to wait until the transmission is completed or to immediately stop the transmission.

In addition, the display device of the second reproduction device according to the present embodiment displays a selection window to select whether the contents are reproduced from the point where the contents are stopped in the first reproduction device by using the contents data and the reproduction stopping point information stored in the storage medium 430.

FIG. 8 is a flowchart illustrating a method of seamlessly reproducing contents according to an embodiment of the present general inventive concept.

In operation 810, the contents being reproduced in the first reproduction device are input from the first reproduction device.

In operation 820, when the reproduction of the contents is stopped in the first reproduction device, the contents reproduction stopping point information is input from the first reproduction device.

In operation 830, in order for the contents to be seamlessly reproduced from the second reproduction device the contents and the contents reproduction stopping point information are output to the second reproduction device by using the contents reproduction stopping point information.

According to the present embodiment, since a speed to store contents is faster than a speed to reproduce the contents in the method and device to seamlessly reproduce contents by using a storage medium, contents are reproduced and stored simultaneously in a previous reproduction device and the contents are stored in the storage medium in advance. Therefore, since the user uses the storage medium to which the contents are stored in advance, the waiting time to move the contents is reduced and the corresponding contents can be rapidly and conveniently reproduced in the next reproduction device.

In the present general inventive concept, the contents and content reproduction stopping point information in the previous reproduction device are stored together in the storage medium so that the contents can be seamlessly enjoyed according to a user's choice made by using the content reproduction stopping point information in the next reproduction device.

In addition, in order to enable seamless reproduction of the contents from the previous reproduction device to the next reproduction device, the user can easily select or use a seamless reproduction function through a GUI to indicate whether to wait to store the contents in the storage medium and a current reproduction state or storing state of the contents.

Moreover, since the existing portable storage medium is used for the seamless reproduction function, a separate high-speed storage device is not needed. Instead, the function of the present general inventive concept can be realized with just a software patch with respect to the existing device and thus can be widely used due to high compatibility with existing technologies.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

While the present general inventive concept has been particularly illustrated and described with reference to exemplary embodiments thereof, it will be understood by those of ordinary skill in the art that various changes in form and details may be made therein without departing from the spirit and scope of the present general inventive concept as defined by the following claims.

What is claimed is:

1. A method of seamlessly reproducing contents, the method comprising:
receiving contents being reproduced in a first reproduction device from the first reproduction device;
when the reproduction of the contents is stopped in the first reproduction device, receiving contents reproduction stopping point information from the first reproduction device; and
outputting the contents and the contents reproduction stopping point information to a second reproduction device by using the contents reproduction stopping point information.

2. The method of claim 1, wherein receiving the contents comprises:
determining whether a reproduction method of the contents is changed in the first reproduction device and, if so, converting the contents according to the changed reproduction method based on the determination result of the first reproduction device.

3. The method of claim 1, wherein receiving the contents comprises:
reproducing the contents in the first reproduction device and simultaneously receiving the contents from the beginning from the first reproduction device.

4. The method of claim 1, wherein in the receiving of the contents, a speed of storing the contents is faster than a speed of reproducing the contents.

5. The method of claim 2, wherein the reproduction method comprises:
at least one of a compressed format, a total capacity of data, and a resolution of the contents.

6. The method of claim 1, wherein receiving contents reproduction stopping point information comprises:
determining whether to wait until all contents are completely stored at the contents reproduction stopping point.

7. The method of claim 1, wherein outputting the contents and the contents reproduction stopping point information to the second reproduction device comprises:
determining whether the contents are reproduced from the reproduction stopping point in the second reproduction device by using the contents and the contents reproduction stopping point information.

8. The method of claim 1, wherein the first reproduction device displays a contents reproduction screen, a current contents reproducing location, and a current transmitting location.

9. A device to seamlessly reproduce contents, the device comprising:
a contents input unit to receive contents being reproduced in a first reproduction device from the first reproduction device;
a reproduction stopping point input unit to receive contents reproduction stopping point information from the first reproduction device, when the reproduction of the contents is stopped in the first reproduction device; and
a contents output unit to output the contents and the contents reproduction stopping point information to a second reproduction device by using the contents reproduction stopping point information, in order for the contents to be seamlessly reproduced in the second reproduction device.

10. The device of claim 9, wherein the contents input unit comprises:
a converting unit to determine whether a reproduction method of the contents is changed in the first reproduction device and converts the contents according to the changed reproduction method based on the determination result of the first reproduction device.

11. The device of claim 9, wherein in the contents input unit, the first reproduction device reproduces the contents and simultaneously receives the contents from the beginning from the first reproduction device.

12. The device of claim 9, wherein in the contents input unit, a speed of storing the contents is faster than a speed of reproducing the contents.

13. The device of claim 9, wherein in the reproduction method comprises:
at least one of a compressed format, total capacity of data, and a resolution of the contents.

14. The device of claim 9, wherein the reproduction stopping point input unit determines whether to wait until all contents are completely stored at the contents reproduction stopping point.

15. The device of claim 9, wherein the contents output unit comprises:
a seamless reproduction determining unit to determine whether the contents are reproduced from the reproduction stopping point in the second reproduction device by using the contents and the contents reproduction stopping point information.

16. The device of claim 9, wherein the first reproduction device displays a contents reproduction screen, a current contents reproducing location, and a current transmitting location.

17. A computer readable recording medium having embodied thereon a computer program to execute a method, the method comprises:
receiving contents being reproduced in a first reproduction device from the first reproduction device;
when the reproduction of the contents is stopped in the first reproduction device, receiving contents reproduction stopping point information from the first reproduction device; and outputting the contents and the contents reproduction stopping point information to the second reproduction device by using the contents reproduction stopping point information.

18. A content reproduction apparatus, comprising:
a storage medium; and
a reproduction device to reproduce content by moving the content from a point where reproduction of content is stopped to a point where reproduction begins in an other reproduction device through the storage medium.

19. A content reproduction system, comprising:
a storage medium to store content;
a display device to display the content; and
a reproduction device to simultaneously transmit the content to the storage medium and the display device.
